(19) United States
(12) Patent Application Publication
(10) Pub. No.: US 2008/0238583 A1
(43) Pub. Date: Oct. 2, 2008

(54) DISCRETE COMPONENT ELECTROMAGNETIC COUPLER

(76) Inventors: Todd R. Shelton, DuPont, WA (US); Bram Leader, Gig Harbor, WA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/694,939

(22) Filed: Mar. 30, 2007

(51) Int. Cl. H01P 5/00

(52) U.S. Cl. 333/24 R

(57) ABSTRACT

In some embodiments a discrete component electromagnetic coupler includes an input and an output, wherein a signal to be observed passes through the coupler via the input and the output, a coupler to transfer energy through electromagnetic effects to a second output, and a termination point to ground through a resistance. Other embodiments are described and claimed.

### TECHNICAL FIELD

The inventions generally relate to a discrete component electromagnetic coupler.

### BACKGROUND

Current electromagnetic (EM) couplers include edge couplers and broadside couplers. Edge EM couplers can be co-located on the same layer of a multi-layer printed circuit board (PCB) or substrate. Broadside EM couplers can be created by closely interfacing traces on a flexible circuit substrate with micro-strip traces on a PCB. Broadside EM couplers can also be created by co-locating traces on adjacent layers of a multi-layer PCB. Each of these EM solutions requires bus signals to be observed on the platform to have a specific coupler structure, length, and tight mechanical geometries. This can impose significant constraints on the platform layout, making it difficult if not impossible to satisfy. When using broadside couplers, an implementation can require unusual PCB stack-ups and exotic materials, resulting in a complex custom solution that may not be transferable to other designs.

Two current probing implementations of EM coupler designs exist as a mid-bus solution and an interposer solution. Both solutions are necessary for bus signal observability on a platform, and both add considerable constraints to the system. Further, the system adds similar constraints to the interposer development, which is processor dependent. An interposer solution using embedded broadside couplers has the added constraint of EM couplers existing within the circuit board itself. Current probing coupler designs require the signal to be coupled (that is, a line under test or LUT) to exist within the constraints of the system to be observed, and/or require both the signal to be coupled (LUT) and the coupling element to exist within the constraints of the system to be observed.

An “Electromagnetic Coupler” is described in U.S. Pat. No. 6,573,801 and an “Electromagnetically-Coupled Bus System” is described in U.S. Pat. No. 6,625,682. These patents describe electromagnetic couplers and a possible implementation of electromagnetic couplers in a bus system. The coupler implementations are described as a flex circuit and motherboard combination producing a broadside coupling element, and as two traces embedded in a printed circuit board to produce broadside and/or edge coupling elements.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates an apparatus according to some embodiments of the inventions.

FIG. 2 illustrates a system according to some embodiments of the inventions.

FIG. 3 illustrates a system according to some embodiments of the inventions.

FIG. 4 illustrates a system according to some embodiments of the inventions.

FIG. 5 illustrates a system according to some embodiments of the inventions.

### DETAILED DESCRIPTION

Some embodiments of the inventions relate to a discrete component electromagnetic coupler (for example, a discrete component electromagnetic coupler probe).

In some embodiments a discrete component electromagnetic coupler includes an input and an output, wherein a signal to be observed passes through the coupler via the input and the output, a coupler to transfer energy through electromagnetic effects to a second output, and a termination point to ground through a resistance.

In some embodiments coupling elements are implemented in a discrete component that can be manufactured using an independent set of design parameters from a system under test. In some embodiments coupler elements are designed with technologies that require costly manufacturing processes and/or materials without imposing these same design constraints or costs on the system implementing the components.

In some embodiments electromagnetic coupler properties may be used in bus architecture design and/or validation activities (for example, in probing activities) while avoiding additional constraints required for designing a system-integrated coupler.

In some embodiments a discrete coupler component separates the design constraints of a coupler element solution from the requirements of the design under test.

In some embodiments an electromagnetic (EM) coupler is implemented in a discrete component that can be used in a variety of applications without requiring system-specific coupler development in conjunction with the system design.

An electromagnetic (EM) coupler is a four port element including a signal source, a signal destination, a termination point, and a signal out to a recovery Application Specific Integrated Circuit (ASIC). In some embodiments an EM coupler includes an input and output port for the signal to be coupled or observed (line under test or LUT) to pass through. In some embodiments an EM coupler includes a coupling structure that transfers energy through capacitive and inductive (electromagnetic) effects to an output port. In some embodiments an EM coupler includes a termination port to ground through a fixed resistance. In some embodiments an output of an EM coupler is directed to signal processing circuitry in order to create an output signal that closely approximates the original bus signal that passed through the coupler.

In some embodiments discrete coupler components may be developed to allow the couplers to be used in different designs without placing new constraints on the PCB stack-ups or material selections. As coupler technologies improve with the development of new materials and/or methodologies, a designer or validation lab that wishes to implement new and improved designs is not required to redesign the previous platforms to accept the new couplers (if, for example, the couplers are designed to a standard backward compatible footprint). The added cost of more complex materials and/or processes can be localized to the coupler component, and does not require higher costs to be transferred to the platform through the requirement of specialized materials needed to support the coupler elements. This allows both the coupler designer and system designer to meet the specific design requirements independently, and allows better efficiency and optimization. As a result, validation hook implementation on a platform can have a vastly reduced impact on layout schedule.

In some embodiments, companies with designs that can benefit from the characteristics of electromagnetic couplers to produce and/or use electromagnetic coupler components that can be designed to use a standard or common footprint. Rather than designing each coupler and coupler solution to match given design constraints of a particular system, a common coupler can be implemented across a wide variety of platforms as long as the platform facilitates the necessary footprint to populate with a previously designed and validated coupler component. If the coupler characteristics are deemed valuable for design efforts outside of a given company, a coupler component can be provided without any significant technology transfer efforts such as those required by current electromagnetic coupler probe design.

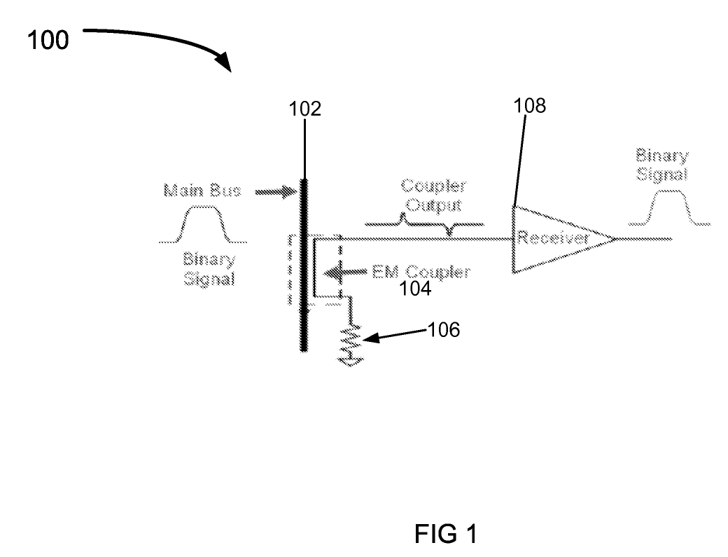

FIG. 1 illustrates an apparatus 100 according to some embodiments. In some embodiments apparatus 100 includes a main bus 102 having a binary signal propagated thereon. An EM coupler 104 is used to couple to the bus 102 (line under test or LUT) to pass through bus signals, for example, for testing, validation, observation, etc. purposes. The EM coupler 104 includes a termination port 106 to ground through a fixed resistance. The EM coupler 104 produces a coupler output signal that is sent to a receiver 108. A binary signal is recovered and output from the receiver 108 to be sent for signal processing purposes. In this manner, an output of the EM coupler 104 creates an output signal that closely resembles the original bus signal passed through the EM coupler. This signal can be provided, for example, to signal processing circuitry.

In some embodiments an implementation of an embedded PCB-based broadside coupler that achieves a separation of coupler design constraints from the system design constraints, but does not describe an actual EM coupler component is referred to as a mid-bus coupler.

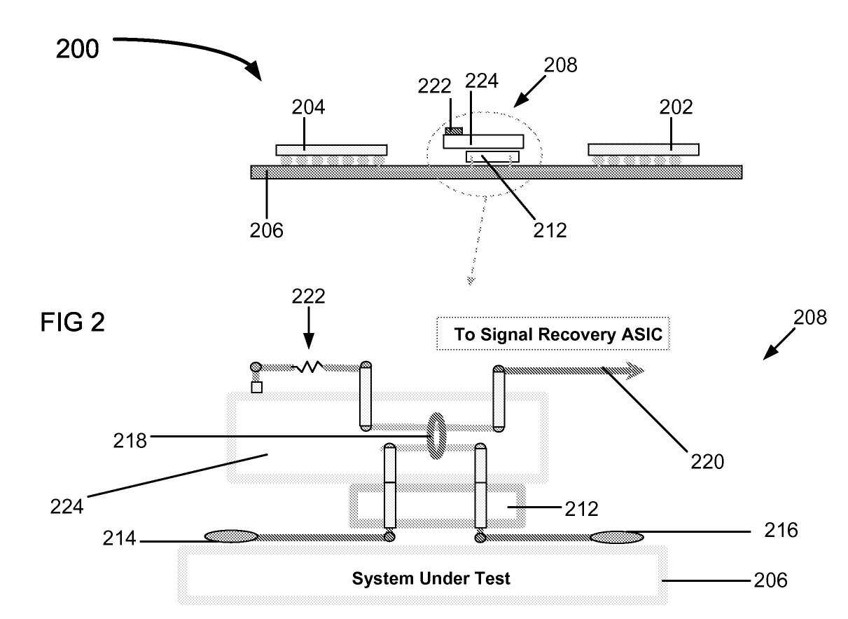

FIG. 2 illustrates a system 200 according to some embodiments. System 200 includes a first integrated circuit (IC) 202 (for example, a microprocessor), a second integrated circuit (IC) 204 (for example, a chip set), a printed circuit board 206 (for example, a motherboard), and a mid-bus assembly EM coupler 208. In some embodiments the IC 202 and/or the IC 204 are coupled to the motherboard 206 via solder and/or other electrical contact material. In order to monitor a signal (for example, a bus signal) provided between the first IC 202 and the second IC 204, a common footprint is established that routes the signals to be monitored from one side of a mid-bus connector 212 to another (for example, between a signal source 216 and a signal destination 214). During normal operation, the signals from one side (for example, from signal source 216) of the connector 212 are passed directly to the other side of the connector 212 (for example, directly to signal destination 214). When observability of the signal is desired, however, the connection between source 216 and destination 214 is broken and a signal is passed (shunted) from one side of the connector 212 to the input of the coupler element 218 (for example, EM coupler element) as the Line Under Test (LUT). The output of the coupler element 218 for the LUT is then routed to the other side of the connector 212, thus restoring the connection for the signal between the IC 202 and the IC 204. The output 220 of the coupler element 218 and a termination to ground 222 can be located on the same PCB as the embedded coupler element 218 or on a separate PCB. In FIG. 2, the embedded coupler element 218 is illustrated as being included on a same mid-bus coupler probe PCB 224 as the output 220 and the termination to ground 220.

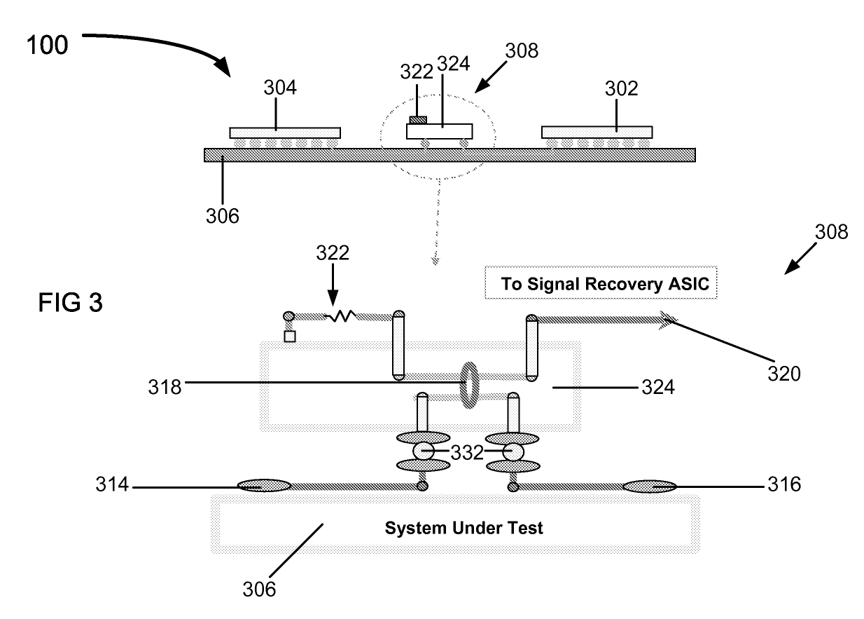

FIG. 3 illustrates a system 300 according to some embodiments. System 300 includes a first integrated circuit (IC) 302 (for example, a microprocessor), a second integrated circuit (IC) 304 (for example, a chip set), a printed circuit board 306 (for example, a motherboard), and a discrete coupler component 308. In some embodiments the IC 302 and/or the IC 304 are coupled to the motherboard 306 via solder and/or other electrical contact material.

The signals are observed between signal source 316 and signal destination 314. Discrete coupler component 308 removes the connector from the mid-bus solution by directly attaching the PCB 324 that contains the embedded coupler 318 to matching footprint pads 332 on the system under test (for example, ball grid array or BGA pads, land grid array or LGA pads, and/or other predefined footprint pads, etc.) In some embodiments, the output 320 of the coupler element 318 (for example, EM coupler element) and the termination to ground 322 can be located on the same discrete coupler component PCB 324 as the embedded coupler elements (or in some embodiments, on a separate PCB).

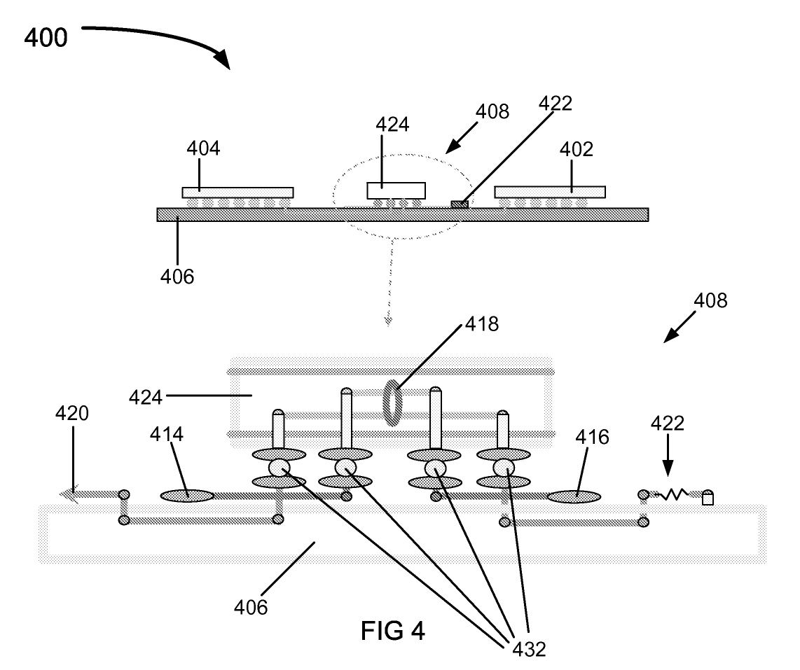

FIG. 4 illustrates a system 400 according to some embodiments. System 400 includes a first integrated circuit (IC) 402 (for example, a microprocessor), a second integrated circuit (IC) 404 (for example, a chip set), a printed circuit board 406 (for example, a motherboard), and a discrete coupler component 408. In some embodiments the IC 402, IC 404, and/or discrete coupler component 408 are coupled to the motherboard 406 via solder and/or other electrical contact material.

The signals are observed between signal source 414 and signal destination 416. Discrete coupler component directly attaches the PCB 424 that contains the embedded coupler 418 to matching footprint pads 432 on the system under test (for example, ball grid array or BGA pads, land grid array or LGA pads, and/or other predefined footprint pads, etc.) In some embodiments, the output 420 of the coupler element 418 and the termination to ground 422 can be located on the system under test (for example, on the motherboard 406). In some embodiments the system under test provides the termination for the coupler as well as the supporting circuitry for recovering the original signal (for example, as illustrated in FIG. 4). In some embodiments coupler signal recovery circuitry and/or termination resistors are mixed at the coupler level and/or at the system level. However, in some embodiments, the constraints of the coupler design are separated from the constraints of the system design.

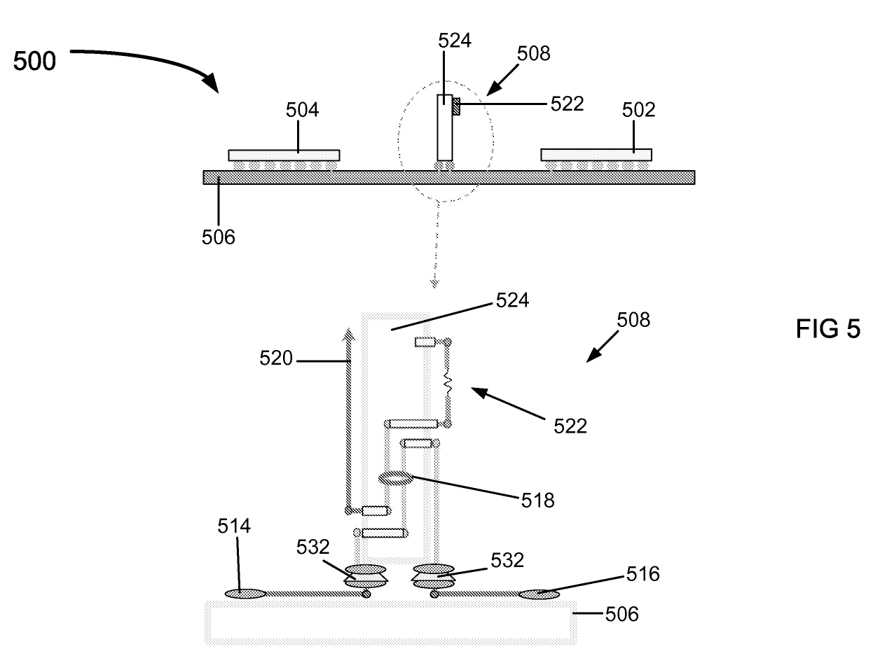

FIG. 5 illustrates a system 500 according to some embodiments. System 500 includes a first integrated circuit (IC) 502 (for example, a microprocessor), a second integrated circuit (IC) 504 (for example, a chip set), a printed circuit board 506 (for example, a motherboard), and a discrete coupler component 508. In some embodiments the IC 502, IC 504, and/or discrete coupler component 508 are coupled to the motherboard 506 via solder and/or other electrical contact material. The signals are observed between signal source 514 and signal destination 516.

In some embodiments variations of discrete EM coupler components (for example, component 508) use the edge of the PCB-based embedded coupler to interface with the system to be observed, as illustrated in FIG. 5. Such a solution provides less space consumed on the system to be observed (system under test), and further minimizes design constraints imposed on the system in order to implement observability using EM couplers.

In some embodiments conventional board materials are used. In some embodiments discrete coupler components are implemented using technologies, materials, and processes that have been developed for more finely detailed dielectric and/or copper features such as semiconductor packaging technologies. Current state of the art PCB manufacturers are producing copper features with resolutions of 1-2 mils, while packages are manufactured to resolutions of fractions of 1 mil. To ensure even finer coupling geometries, semiconductor technologies may be used to produce new types of couplers. Using package materials and/or technologies, it is possible to implement couplers, terminations, and a signal recovery ASIC all integrated into one single packaged component.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A discrete component electromagnetic coupler comprising:
an input and an output, wherein a signal to be observed passes through the coupler via the input and the output;
a coupler to transfer energy through electromagnetic effects to a second output; and
a termination point to ground through a resistance.

2. The coupler of claim 1, further comprising a printed circuit board on which the coupler, the second output, and the termination point are located.

3. The coupler of claim 1, further comprising a substrate on which the coupler, the second output, and the termination point are located.

4. The coupler of claim 1, further comprising a first printed circuit board on which the coupler is located and a second printed circuit board on which the second output and the termination point are located.

5. The coupler of claim 1, further comprising a first substrate on which the coupler is located and a second substrate on which the second output and the termination point are located.

6. The coupler of claim 1, further comprising an electrical connection to couple the input and the output to the coupler.

7. The coupler of claim 1, wherein the discrete component electromagnetic coupler is manufactured using an independent set of design parameters from a system to be observed.

8. The coupler of claim 1, wherein the second output is reconstituted as a signal that approximates the signal to be observed.

9. The coupler of claim 1, wherein the signal to be observed is a bus signal.

10. The coupler of claim 1, wherein the signal to be observed is an electrical signal.

11. The coupler of claim 1, further comprising pads to couple with a system to be observed in which the signal to be observed is located.

12. The coupler of claim 1, wherein the coupler is an embedded printed circuit board based broadside coupler.

13. The coupler of claim 1, wherein the coupler is an edge based printed circuit board coupler.

14. The coupler of claim 1, wherein the coupler is a broadside coupler using any substrate.

15. The coupler of claim 1, wherein the coupler is an edge based coupler using any substrate.

16. The coupler of claim 1, wherein the coupler couples to a system to be observed using an edge of a printed circuit board based coupler.

17. The coupler of claim 1, wherein the coupler is to be used in bus architecture design and/or validation activities.

18. The coupler of claim 1, wherein the coupler is a coupler probe device.

19. The coupler of claim 1, wherein the coupler has a standard footprint.
